(19) United States
(12) Patent Application Publication
(10) Pub. No.: US 2013/0017943 A1
(43) Pub. Date: Jan. 17, 2013

(54) Continuous Centrifuge

(71) Applicants: Hiroatsu Toi, Ibaraki (JP); Eiichi Fukuhara, Ibaraki (JP)

(72) Inventors: Hiroatsu Toi, Ibaraki (JP); Eiichi Fukuhara, Ibaraki (JP)

(73) Assignee: HITACHI KOKI CO., LTD., Tokyo (JP)

(21) Appl. No.: 13/546,576

(22) Filed: Jul. 11, 2012

(30) Foreign Application Priority Data
Jul. 15, 2011 (JP) 2011-156298

(51) Int. Cl. B04B 11/02; B04B 15/00; B04B 15/08

(52) U.S. Cl. 494/2; 494/35; 494/10

(57) ABSTRACT

A continuous centrifuge including: a rotor configured to separate a sample; a centrifuge chamber configured to accommodate the rotor; a driving part configured to rotate the rotor; a sample line configured to continuously supply and discharge the sample to and from the rotor during rotation of the rotor; and an air detecting sensor provided to a supply side and a discharge side of the sample line.

### CROSS-REFERENCE TO RELATED APPLICATIONS

This application claims priority from Japanese Patent Application No. 2011-156298 filed on Jul. 15, 2011, the entire contents of which are incorporated herein by reference.

### TECHNICAL FIELD

Aspects of the present invention relate to a continuous centrifuge capable of centrifuging particles in a liquid sample in an interior of a rotor while continuously supplying the sample. Particularly, aspects of the present invention relate to a continuous centrifuge including an air discharging part which can effectively discharge air included in a sample supply part and a sample line for supplying and discharging the sample to and from a rotor.

### BACKGROUND

A centrifuge is a device for separating particles which are not (or less) sedimented under a normal gravitational field. For example, an object to be separated includes viruses or fungus bodies, etc. The viruses or fungus bodies are essential raw materials for the manufacture of drugs and vaccines, etc. A continuous centrifuge has been widely used as equipment for separating and purifying the raw material during the manufacturing process thereof. The continuous centrifuge includes a rotor rotating at high speed, two rotating shafts connected to an upper and lower side of the rotor and provided with a through hole, and a sample supply part for supplying the sample to the rotor.

As the sample supply part, a system in which a liquid feeding pump for supplying the sample, a flow meter and a pressure meter are connected by silicone tube, etc., is suggested. Further, a sample line which is configured to be sterilized by steam is suggested as the sample supply part (see, for example, JP-A-2006-21121).

During rotation of the continuous centrifuge, it is necessary to completely fill the interior of the rotor with liquid. When the continuous centrifuge is operated in a state where the interior of the rotor is not completely filled with liquid, there is a risk that the rotor becomes an unbalanced state and thus excessive vibration occurs, which is not preferable. In a worst case, the operation of the continuous centrifuge needs to be stopped due to abnormal vibration.

Further, if air remains in the sample line, the pressure in the sample line during injection of the sample increases and thus it may be difficult to inject the sample at a predetermined flow rate. Accordingly, it is important to securely pull out air remaining in the sample line.

A transparent or semi-transparent tube such as a silicone tube or an opaque piping such as a rubber pipe or metal pipe can be employed for piping of the sample line utilized in the continuous centrifuge. In a case where the piping of the sample line employs the semi-transparent tube such as a silicone tube, the presence of air in the sample line can be visually confirmed. Accordingly, it is possible to discharge air from the sample line by a manual operation by an operator. For example, an operator can pick the silicone tube by hands to temporarily increase the pressure of the sample line and then release the pressure.

However, in a case where the piping of the sample line employs the opaque piping such as a rubber pipe or metal pipe, it is difficult to visually confirm the presence of air in the sample line. Particularly, in a case where the metal pipe is employed, it is impossible to perform an operation for picking the metal pipe by hands to temporarily increase the pressure of the sample line. Meanwhile, for the system in which a sample line is configured to be sterilized by steam as disclosed in JP-A-2006-21121, it is essential to use a metal pipe such as stainless pipe in order to withstand steam sterilization. As a result, it is difficult to use the semi-transparent tube such as a silicone tube and thus it is impossible to visually confirm the presence of air in the sample line.

### SUMMARY

The present invention has been made to solve the above-described problem and it is an object of the present invention to provide a continuous centrifuge capable of easily detecting whether air is included in the sample line or not.

Another object of the present invention is to provide a continuous centrifuge including an automation system for securely discharging air in the sample line.

Yet another object of the present invention is to provide a continuous centrifuge in which a series of process including the steam sterilization of the sample line, the injection of the sample, the centrifuging operation, the collection after centrifuging operation and cleaning operation is automated.

Representative aspects of the invention disclosed herein are as follows.

According to an aspect of the invention, there is provided a continuous centrifuge including: a rotor configured to separate a sample; a centrifuge chamber configured to accommodate the rotor; a driving part configured to rotate the rotor; a sample line configured to continuously supply and discharge the sample to and from the rotor during rotation of the rotor; and an air detecting sensor provided to a supply side and a discharge side of the sample line.

According to another aspect of the invention, there is provided a continuous centrifuge including: a rotor configured to separate a sample; a centrifuge chamber configured to accommodate the rotor; a driving part configured to rotate the rotor; a sample line configured to continuously supply and discharge the sample to and from the rotor during rotation of the rotor; a display part configured to display an operation state; and an air detecting sensor provided to a supply side and a discharge side of the sample line, wherein the display part is configured to display whether air is detected by the air detecting sensor or not.

According to another aspect of the invention, there is provided a continuous centrifuge including: a rotor configured to separate a sample; a centrifuge chamber configured to accommodate the rotor; a driving part configured to rotate the rotor; a sample line configured to continuously supply and discharge the sample to and from the rotor during rotation of the rotor; and an air detecting sensor provided to the sample line.

### BRIEF DESCRIPTION OF DRAWINGS

FIG. 1 is a perspective view illustrating a whole configuration of a continuous centrifuge 1 according to an exemplary embodiment of the present invention;

FIG. 2 is a sectional view illustrating a detailed configuration of a centrifuging section 100 of FIG. 1 and a piping diagram of a sample circulation part;

FIG. 3 is a view illustrating an example of a screen displayed in an operating panel 205 of FIG. 1;

FIG. 4 is a control block diagram illustrating a continuous centrifuge 1 according to the present exemplary embodiment; and

FIG. 5 is a flowchart illustrating a liquid feeding check process using a liquid feeding unit 230 according to the present exemplary embodiment.

### DETAILED DESCRIPTION

### Exemplary Embodiment 1

Hereinafter, an exemplary embodiment of the present invention will be described by referring to the accompanying drawings. In the following drawings, same reference numerals will be given to the same components and a repetitive description thereof will be omitted.

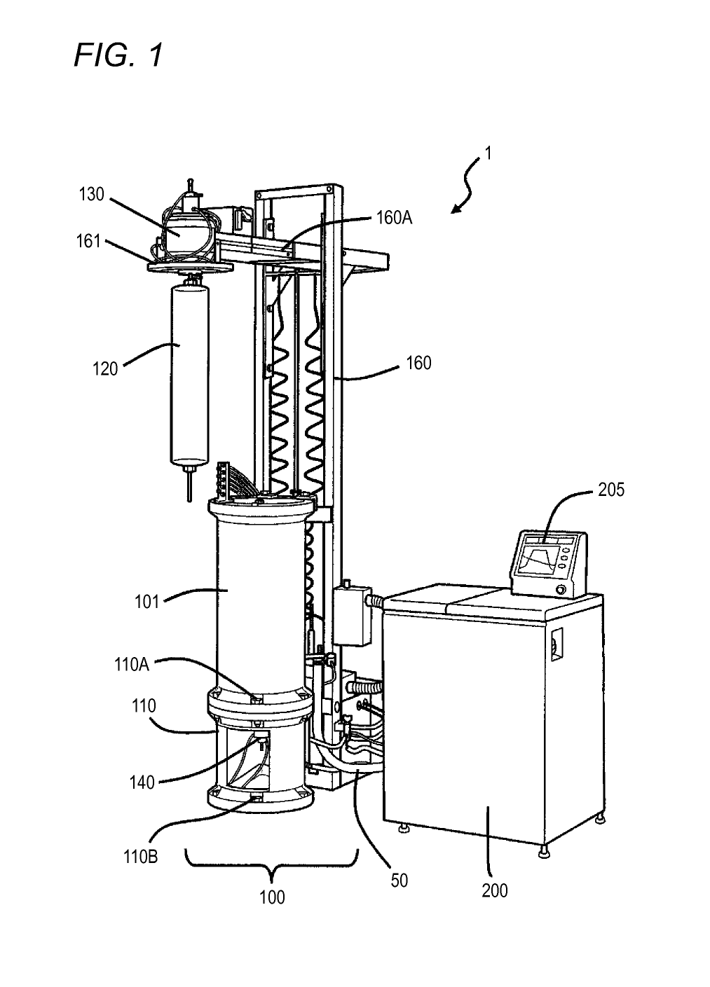

FIG. 1 is a perspective view illustrating a whole configuration of a continuous centrifuge 1 according to the present exemplary embodiment. As illustrated in FIG. 1, the continuous centrifuge 1 is a so-called “continuous ultracentrifuge” used in a process such as a vaccine manufacturing process. The continuous centrifuge 1 includes two essential sections of a centrifuging section 100 and a control device section 200. The centrifuging section 100 and the control device section 200 are connected to each other by a wiring/piping group 20.

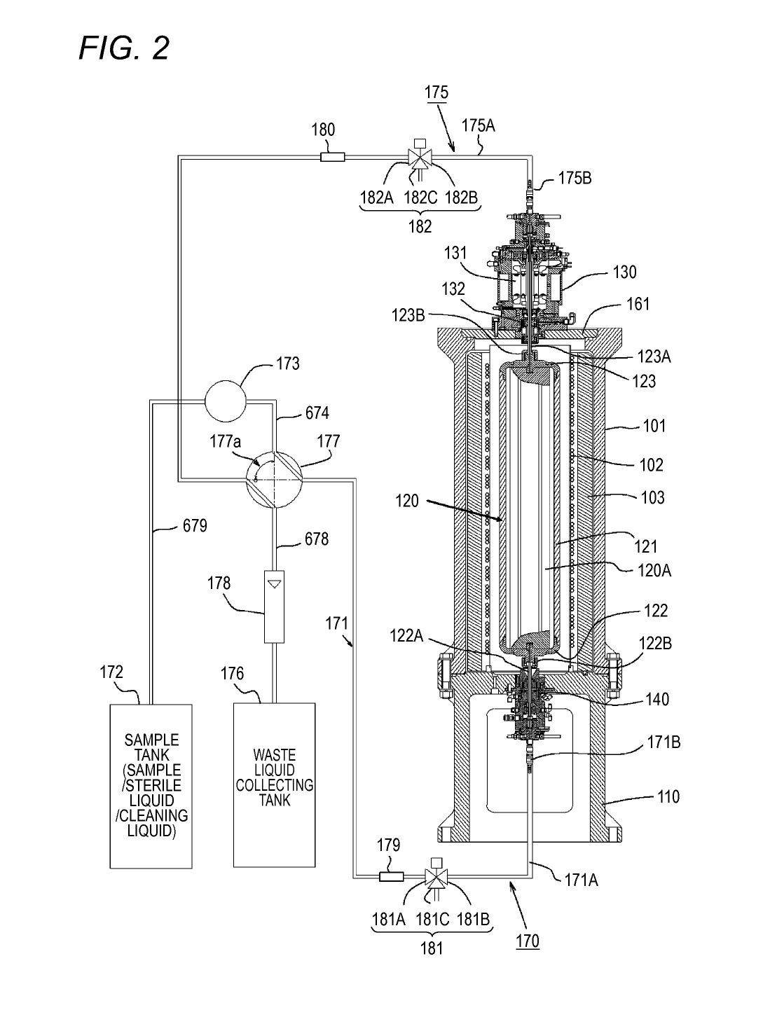

The centrifuging section 100 includes a cylindrical chamber 101 as a centrifuging chamber, a base 110 for supporting the chamber 101, a rotor 120 accommodated in the chamber 101 to be freely moved in and out of the chamber 101 and configured to rotate at high speed, a driving part 130 disposed at an upper portion of the chamber 101 to rotationally drive the rotor 120 suspended from the driving part 130, a lower bearing part 140 disposed at a lower portion of the chamber 101, a lift 160 and an arm 160A for moving the driving part 130 in vertical and longitudinal direction, and a sample circulation part 170 for continuously supplying and discharging a sample or sterile liquid to and from the rotor 120 (see, FIG. 2). The rotor 120 suspended from the driving part 130 is accommodated inside the chamber 101.

Since the rotor 120 is rotationally driven at high speed, the interior of the chamber 101 is maintained at a reduced pressure during centrifuging operation in order to suppress the heat generated due to a windage loss or a frictional heat between an atmosphere and the rotor when the rotor is operated. In order to maintain the pressure inside the chamber 101 at a reduced pressure, a discharge port (not-illustrated) for discharging air inside the chamber 101 is formed on a body portion of the chamber 101 and a vacuum pump (not-illustrated) is connected to the discharge port. The chamber 101 is fixed to the base 110 by a plurality of bolts 110A and the base 110 is fixed to a floor by a plurality of bolts 110B.

The control device section 200 accommodates a cooling device (not-illustrated) for cooling the entire centrifuging chamber inside the chamber 101, a vacuum pump (not-illustrated) for maintaining the centrifuging chamber inside the chamber 101 at a reduced pressure, a lift driving device (not-illustrated) for moving the rotor 120 to a predetermined place and a centrifuge controller (control unit) for driving and controlling the rotor 120. An operating panel 205 as an operating and inputting member is disposed on an upper portion of the control device section 200. The control unit is configured by an electronic circuit including a microcomputer (not-illustrated) and a storage device. The control unit is configured to drive and control not only the rotor 120 but the entire continuous centrifuge.

FIG. 2 is a sectional view illustrating a detailed configuration of the centrifuging section 100 of FIG. 1. The rotor 120 suspended from the driving part 130 is accommodated inside the chamber 101. A cylindrical evaporator (evaporation pipe) 102 is provided to cover the periphery of the rotor 120. Further, a cylindrical protector 103 is provided on the outside of the evaporator 102. The protector 103 is configured to prevent the debris of the rotor or sample from being scattered to the exterior and hold the debris or sample in the chamber 101, even if the rotor 120 is broken for any reason during rotation thereof. In this way, the protector serves as a protective barrier. The evaporator 102 is configured by a copper piping through which refrigerant gas circulates to cool the interior of the chamber 101. The evaporator 102 can cool the interior of the chamber 101.

The rotor 120 includes a cylindrical rotor body 121, an upper rotor cover 123 and a lower rotor cover 122. The upper rotor cover 123 and the lower rotor cover 122 are screw-mounted on a lower portion and an upper portion of the rotor body 121. The driving part 130 is mounted on an upper plate 161 (will be described later) integral with a lift 160 (see, FIG. 1) and includes a motor 131, a bearing part 132, etc. The motor 131 uses an upper shaft 123A as a rotation axis. The bearing part 132 is configured to rotatably support the upper shaft 123A on the upper and lower portions of the motor 131. Since the upper rotor cover 123 is mounted on a lower end of the upper shaft 123A via a nut 123B, the rotor 120 is suspended from the driving part 130.

Sample passing holes are respectively provided on an axial center location of each of the upper rotor cover 123 and the lower rotor cover 122. The upper shaft 123A and a lower shaft 122A serving as a rotation axis are attached to the upper rotor cover 123 and the lower rotor cover 122. Sample passing holes serving as an upper passage and a lower passage are provided to penetrate through an axial center location of each of the upper shaft 123A and the lower shaft 122A. These sample passing holes communicate with the sample passing holes respectively formed on the upper rotor cover 123 and the lower rotor cover 122. As the upper shaft 123A rotates at high speed in accordance with the driving of the motor 131 included in the driving unit 130, both the rotor 120 attached to the upper shaft 123A and the lower shaft 122A attached to the rotor 120 by a nut 122B rotate at high speed.

Further, a core 120A is provided inside the rotor 120 in such a way that the core can be moved into and out of the rotor. When centrifuging operation is performed, a sample injected from the lower shaft 122A is introduced into inside the rotor 120 through the sample passing hole. And, the sample introduced inside the rotor 120 is moved to a high centrifugal force field by the core 120A and then separated into precipitate and supernatant. The supernatant (waste liquid) is discharged through the sample passing hole of the upper shaft 123A.

The sample circulation part 170 is mainly configured by the rotor 120, the lower shaft 122A, the upper shaft 123A, a lower pipe 171, a sample tank 172, a liquid feeding pump 173, an upper pipe 175, a waste liquid collecting tank 176, a direction switching valve 177, a flow sensor 178, a lower air detecting sensor 179, an upper air detecting sensor 180, a lower three-way valve 181 and an upper three-way valve 182.

The lower bearing part 140 and the direction switching valve 177 are connected to each other by the lower pipe 171. The lower pipe 171 includes a lower connection pipe 171A placed between the lower pipe 171 and the lower bearing part 140 and a lower connector 171B placed at the connection side with the continuous centrifuge 1. Further, the driving part 130 and the direction switching valve 177 are connected to each other by the upper pipe 175. The upper pipe 175 includes an upper connection pipe 175A placed between the upper pipe 175 and the driving part 130 and an upper connector 175B placed at a connection side with the continuous centrifuge 1. The lower bearing part 140 is provided at a position of the base 110 contacting the chamber 101.

The sample to be centrifuged by the rotor 120 is accumulated in the sample tank 172 and pumped by the liquid feeding pump 173. It is determined whether the sample pumped by the liquid feeding pump 173 is sent to the lower pipe 171 or the upper pipe 175 depending on a direction setting of the direction switching valve 177. Here, referring to FIG. 2, the direction of the direction switching valve 177 is set to pump the sample to the lower pipe 171. The sample passing through the direction switching valve 177 flows into the rotor 120 through the lower bearing part 140 and then is centrifuged by the rotor. And then, supernatant of the sample separated by the rotor 120 goes through the driving part 130, passes through the direction switching valve 177 and then is collected in the waste liquid collecting tank 176.

Meanwhile, as the direction switching valve 177 rotates from the state of FIG. 2 by 90 degrees in a direction of arrow 177a, the cleaning liquid or the sterile liquid pumped by the liquid feeding pump 173 flows into the rotor 120 via the driving part 130 and the waste liquid of the cleaning liquid or the sterile liquid separated by the rotor 120 goes through the lower bearing part 140, passes through the direction switching valve 177 and then is collected in the waste liquid collecting tank 176.

The flow sensor 178 is interposed between the direction switching valve 177 and the waste liquid collecting tank 176. The flow sensor 178 is a sensor for measuring the capacity (per unit of time) of the liquid flowing into the waste liquid collecting tank 176. Conventional flow sensor can be used as the flow sensor 178. In the present exemplary embodiment, a series of lines (flow path) from the sample tank 172 to the waste liquid collecting tank 176 is defined as “a sample line”.

The lower air detecting sensor 179 and the lower three-way valve 181 are inserted in a portion of the lower pipe 171. The lower air detecting sensor is a sensor for detecting whether liquid is present in the flow path or not, for example. As an example, the lower air detecting sensor is a sensor for determining the presence of the liquid in the flow path by irradiating a light from one sidewall side of the flow path, receiving the light by an optical sensor provided on an opposite sidewall side thereof and checking the intensity of the received light. From different viewpoint, the lower air detecting sensor 179 is a sensor for detecting liquid and a detecting method is optional. For example, the lower air detecting sensor 179 may detect whether a predetermined position of the flow path is filled with liquid or air (that is, air is included therein). The lower three-way valve 181 is a control valve of which opening and closing can be controlled by the control unit. In the present exemplary embodiment, the lower three-way valve 181 is an electromagnetic three-way valve. Typically, a passage 181A is communicated with a passage 181B via the lower three-way valve 181 to form a flow path through which the sample is supplied from the sample tank 172 toward the rotor 120. As the lower three-way valve 181 is switched, the passage 181A or the passage 181B can be connected to a passage 181C for discharging the air to the exterior.

The upper air detecting sensor 180 and the upper three-way valve 182 are inserted in a portion of the upper pipe 175. The upper air detecting sensor 180 having the same configuration as the lower air detecting sensor 179 can be used. In the present exemplary embodiment, the upper three-way valve 182 is an electromagnetic three-way valve of which opening and closing can be controlled by the control unit. Typically, a passage 182A is communicated with a passage 182B via the upper three-way valve 182 to form a flow path through which the centrifuged supernatant flows from the rotor 120 toward the waste liquid collecting tank 176. By switching the upper three-way valve 182, the passage 182A or the passage 182B can be connected to a passage 182C for discharging the air to the exterior. Note that, although an electromagnetic valve for opening and closing the flow path by electric operation is used as the lower three-way valve 181 and the upper three-way valve 182 in the present exemplary embodiment, other types of valves, for example, a pneumatic valve for switching or closing a flow path by high pressure air can also be used as the lower three-way valve 181 and the upper three-way valve 182.

When the sample reserved in the sample tank 172 is injected to the rotor 120 by the liquid feeding pump 173, the direction switching valve 177 is switched to a lower side and then the sample is injected through the lower pipe 171. At this time, first, the lower air detecting sensor 179 can detect the start of the sample injection to the rotor 120 and the upper air detecting sensor 180 can detect whether the sample fills the rotor 120 to be overflowed or not. These detections are controlled by a control unit (liquid feeding controller 240 in FIG. 4) which will be described later.

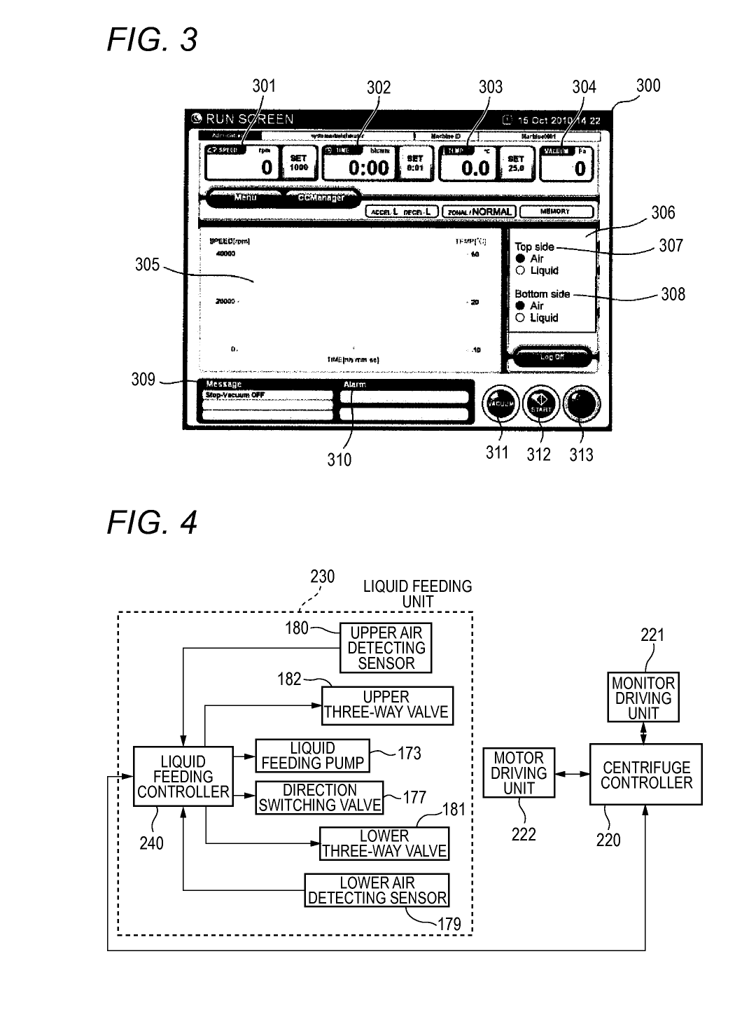

When it is found that no air is detected by both the lower air detecting sensor 179 and the upper air detecting sensor 180, the control unit determines that the rotor 120 is filled with the sample and thus the rotation of the rotor 120 can be started. In the example of FIG. 3, the upper air detecting sensor 180 is placed at the waste liquid collecting tank 176 side of the upper three-way valve 182. However, the upper air detecting sensor 180 may be placed at a position adjacent to the rotor 120 side of the upper three-way valve 182. Further, two upper air detecting sensors 180 may be prepared and the upper three-way valve 182 may be provided between the two upper air detecting sensors 180. This arrangement of air detecting sensor can be similarly applied to the lower three-way valve 181.

FIG. 3 is a view illustrating an example of a screen displayed in an operating panel 205. The operating panel 205 is constituted by a touch-sensitive liquid crystal display screen, for example. A rotation speed display part 301 (unit: rpm) for the rotor 120, an elapsed time display part 302 (unit: hours and minutes), a chamber temperature display part 303 (unit: ° C.) and a chamber vacuum degree display part 304 (unit: Pa) are provided on an upper side of a display screen 300.

Each of the rotation speed display part 301, the elapsed time display part 302 and the chamber temperature display part 303 includes a region displaying the current condition in the left side thereof and a region displaying the setting condition in the right side thereof. A trend display part 305 is provided in the middle portion of the display screen 300 to display the progress of rotation speed and temperature of the rotor 120 with respect to elapsed time. FIG. 3 illustrates an example of a graph in which the horizontal axis represents time and the vertical axis represents the rotation speed of the rotor and the temperature of the rotor. However, since FIG. 3 illustrates a state before a centrifuging operation is started, nothing is displayed on the graph. Based on the displayed graph, an operator can recognize immediately whether the progress of the rotation speed and temperature of the rotor 120 is normal or not.

A liquid feeding state display part 306 is provided in a region at the right side of the trend display part 305 to display the detection state of the upper air detecting sensor 180 and the lower air detecting sensor 179. The detection state of the upper air detecting sensor 180 is displayed as “Top side” 307 on the liquid feeding state display part 306. In this case, either of “Air” representing the presence of the air is marked or “Liquid” representing the presence of the liquid is marked, in accordance with the detection result of the upper air detecting sensor 180. FIG. 3 indicates that air is present at a portion of the upper air detecting sensor 180. Similarly, the detection state of the lower air detecting sensor 179 is displayed as “Bottom side” 308, which is provided below the “Top side” 307. FIG. 3 indicates that air is present at a portion of the lower air detecting sensor 179.

A message display part 309 for displaying a message to be transmitted to an operator and an alarm display part 310 for displaying an alarm to an operator when any abnormality occurs are provided in a lower region of the trend display part 305. In FIG. 3, a “Stop-Vacuum-Off” message for displaying the stopping state of the vacuum pump is indicated in the message display part 309. By this message, an operator can recognize the state during the operation. Furthermore, a vacuum button 311 for driving a vacuum pump (not-illustrated) to reduce the pressure in the chamber 101, a start button 312 for starting the rotation of the rotor 120 and a stop button 312 for stopping the rotor 120 during rotation are displayed in the lower right portion of the display screen 300.

Meanwhile, the display screen illustrated in FIG. 3 is represented as an example and various operating screens can be displayed on the operating panel 205. Further, the operating panel of FIG. 3 is illustrated in gray scale but color display can be employed. In fact, if the color display is employed, it is possible to realize a user-friendly operating panel 205 having a good visibility. Further, acoustic equipments such as speaker or buzzer may be provided to make a touch sound or to make an alarm sound in accordance with the operation of the operating panel 205.

Next, the control block diagram of the continuous centrifuge 1 according to the present exemplary embodiment will be described by referring to FIG. 4. The continuous centrifuge 1 is entirely controlled by a centrifuge controller 220 which is accommodated in the control device section 200. The centrifuge controller 220 includes a microcomputer (not-illustrated) and performs a variety of controls by executing a plurality of programs (not-illustrated). Further, a primary storage device and secondary storage device or communication equipment for communication with external equipment are provided in the centrifuge controller 220.

A monitor driving unit 221 is connected to the centrifuge controller 220. The monitor driving unit 221 is configured to display information on the display screen 300 and output positional information of the touched position on the display screen 300 to the centrifuge controller 220. A motor driving unit 222 supplies a predetermined driving current to the motor 131 and thus the motor 131 rotates at a predetermined rotation speed. When a brushless DC motor is used as the motor 131, it is preferable that an inverter circuit is included in the motor driving unit 222. Instructions such as a starting operation, acceleration, constant speed rotation, deceleration and stopping operation of the motor 131 are performed by the centrifuge controller 220.

The liquid feeding unit 230 includes the liquid feeding pump 173 for pumping any one of the sample, the sterile liquid or the cleaning liquid from the sample tank 172, the direction switching valve 177 for switching the flow direction of the sample between the lower pipe 171 and the upper pipe 175 and an air discharging part for discharging air included in the liquid pumped by the liquid feeding pump 173. The air discharging part includes the liquid feeding controller 240, the lower three-way valve 181, the upper three-way valve 182, the lower air detecting sensor 179 and the upper air detecting sensor 180. The liquid feeding controller 240 controls the lower three-way valve 181 and the upper three-way valve 182 in accordance with the output of the lower air detecting sensor 179 and the upper air detecting sensor 180, in addition to driving the liquid feeding pump 173 and controlling the direction switching valve 177. In the present exemplary embodiment, the liquid feeding controller 240 is configured to control the air discharge independently from the centrifuge controller 220. However, the centrifuge controller 220 may be configured to concurrently serve as the liquid feeding controller 240 without providing an independent liquid feeding controller 240.

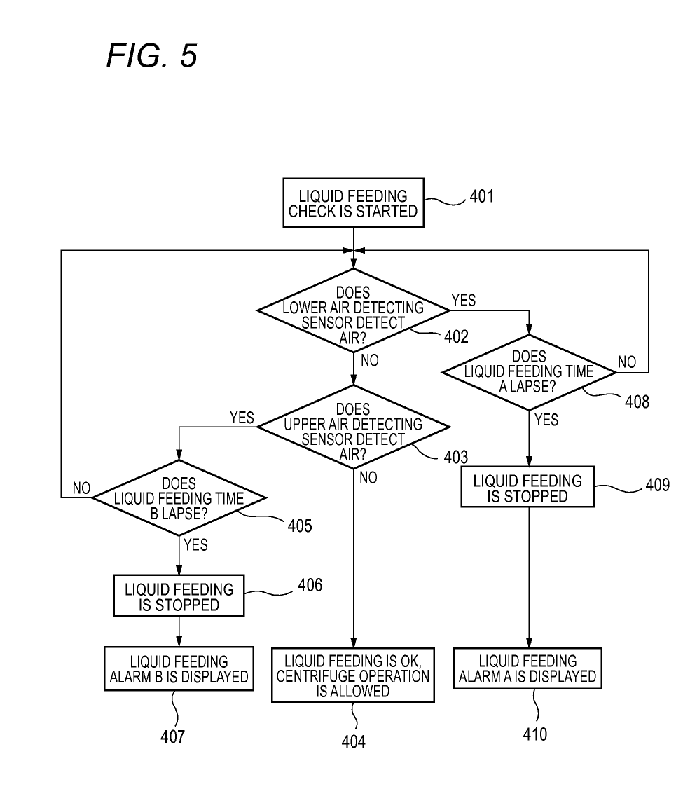

Next, the liquid feeding check process using the liquid feeding controller 240 will be described by referring to the flowchart of the FIG. 5. The process illustrated in FIG. 5 can be realized by software as a microprocessor included in the liquid feeding controller 240 executes a computer program. Further, the liquid feeding check process is performed in parallel to a control of the motor driving unit 222 by the centrifuge controller 220, a control of a cooling device (not-illustrated), a control of the monitor driving unit 221, etc.

First, the following operations are performed by an operator. Liquid is supplied into the sample tank 172, the waste liquid collecting tank 176 is setup, the direction switching valve 177 is setup to a state (lower supply state) illustrated in FIG. 2 and then the liquid feeding pump 173 is driven to start the liquid feeding operation. As the liquid feeding operation is started, the liquid feeding controller 240 carries out the execution of the flowchart of FIG. 5 (step 401).

As the sample is injected, the liquid feeding controller 240 determines whether the lower air detecting sensor 179 detects the presence of air or not (step 402). In consideration of the length of the piping from the sample tank to the lower air detecting sensor 179 and the flow rate of the liquid feeding pump 173, a state where air is detected by the lower air detecting sensor 179 is maintained until a predetermined time lapses after the sample feeding operation is started. Accordingly, when air is detected in step 402, subsequently, it is determined whether an allowed time (that is, liquid feeding time A) required for the liquid feeding lapses or not (step 408). When it is determined that the liquid feeding time A has not elapsed, the process returns to step 402. At this time, if the liquid feeding operation is smoothly performed, there will be no air in the region of the lower air detecting sensor 179 before reaching the liquid feeding time A.

In step 408, when air is still detected even after the liquid feeding time A (for example, 30 seconds) has lapsed, it is determined that there is a trouble in somewhere of the sample line such as the liquid feeding pump 173. Accordingly, the liquid feeding controller 240 stops the liquid feeding operation (step 409). At this time, the liquid feeding controller 240 alerts a liquid feeding alarm A which represents an abnormality of the liquid feeding state to an operator and informs the abnormality of the liquid feeding state to the centrifuge controller 220 (step 410).

In step 402, when liquid reaches a region of the lower air detecting sensor 179 before reaching the liquid feeding time A, subsequently, it is determined whether the presence of air is detected by the upper air detecting sensor 180 or not (step 403). Immediately after liquid is fed to the rotor 120, the rotor 120 is filled with the liquid. Further, air is still detected by the upper air detecting sensor 180 until the liquid passes through the piping from the rotor 120 to the upper air detecting sensor 180. Accordingly, when air is detected at step 403 (YES in step 403), subsequently, it is determined whether an allowed time (that is, liquid feeding time B) required for the liquid feeding lapses or not (step 405).

When it is determined that the liquid feeding time B has not lapsed, the process returns to step 402. At this time, if the liquid feeding operation is smoothly performed, there will be no air in the region of the upper air detecting sensor 180 before reaching the liquid feeding time B (step 405, step 403). Accordingly, the liquid feeding operation is in a normal state (liquid feeding OK) and the operation of the centrifuge is allowed (step 404). In a state of the “liquid feeding OK”, a control mode to be executed can be optionally set. For example, when the liquid feeding operation is in the state of the “liquid feeding OK”, the rotor 120 is automatically started to rotate and thus a so-called auto-start function may be obtained. Further, in the state of the “liquid feeding OK”, the display part may display the “liquid feeding OK” and cause an operator to touch (or push) the start button 312. Upon displaying “liquid feeding OK”, it is desirable to alert an alarm to an operator by sound, in addition to screen display.

In step 405, when air is still detected even after the liquid feeding time B (which is determined from the capacity of the rotor 120 and the flow rate of the liquid feeding pump 173) has lapsed, it is determined that there is a high possibility that the sample is leaking from the rotor 120. Accordingly, the liquid feeding controller 240 stops the liquid feeding operation (step 406). At this time, the liquid feeding controller 240 alerts a liquid feeding alarm B which represents an abnormality of the liquid feeding state to an operator and informs the abnormality of the liquid feeding state to the centrifuge controller 220 (step 410).

After the liquid feeding check process is carried out as mentioned above, the operation of the centrifuge is started after the state of step 404. In a state where air is not detected by the lower air detecting sensor 179 and the upper air detecting sensor 180 and the rotor 120 is normally rotated after the start of the operation, it is necessary to continuously inject the sample into the rotor 120. At this time, if air is present in the sample line, the pressure in the sample line increases and thus it may be difficult to inject the sample at a predetermined flow rate. For example, there is a case that the sample tank 172 is provided in plural, the sample tank 172 in connection is empty and thus next sample tank 172 is switched to a connected state. In this case, it is important to securely pull out air in the sample line.

Accordingly, when air is detected by the lower air detecting sensor 179 and the upper air detecting sensor 180 which are provided in the sample line, the liquid feeding controller 240 controls to discharge the air through the lower three-way valve 181 and the upper three-way valve 182 which are respectively provided adjacent to the lower air detecting sensor 179 and the upper air detecting sensor 180. The passage 181C as an air discharge line of the lower three-way valve 181 and the passage 182C as an air discharge line of the upper three-way valve 182 are connected to the waste liquid collecting tank 176 or a drainage piping which is not-illustrated.

In order to discharge air inside the lower pipe 171, first, the direction switching valve 177 is set to allow an injection through the lower pipe 171. And then, when air is detected by the lower air detecting sensor 179, the passage 181B is closed and air (sample containing bubble) is discharged through a line from the passage 181A to the passage 181C. When air is not detected by the lower air detecting sensor 179, the passage 181C is closed and a line from the passage 181A to the passage 181B is utilized.

In order to discharge air inside the upper pipe 175, the direction switching valve 177 is set to allow an injection through the upper pipe 175. And then, when air is detected by the upper air detecting sensor 180, the passage 182B is closed and air (sample containing bubble) is discharged through a line from the passage 182A to the passage 182C. When air is not detected by the upper air detecting sensor 180, the passage 182C is closed and a line from the passage 182A to the passage 182B is utilized.

As mentioned above, since the air detecting sensor and the three-way valve are controlled in combination by switching the direction of the direction switching valve 177 in an upper and lower direction at several times, it is possible to securely discharge the air remaining the sample line. Accordingly, it is possible to operate the continuous centrifuge in a stable manner. Further, if the lower air detecting sensor 179 and the upper air detecting sensor 180 are directly provided in the sample line as in the present exemplary embodiment, a sterilizing operation or a cleaning operation can be performed without removing the sensors. Accordingly, usability is very good since there is no need for special handling.

Hereinabove, although the present invention has been described in accordance with the above exemplary embodiments, the present invention is not limited to the above exemplary embodiments and can be variously modified without departing from the scope thereof. For example, although a case where liquid is supplied to the rotor 120 via the lower pipe 171 has been described in the above exemplary embodiment, the present invention is not limited to this case. That is, the present invention may be similarly applied to a case where liquid such as a cleaning liquid is supplied to the rotor 120 via the upper pipe 175 and collected into the waste liquid collecting tank 176 via the lower pipe 171. In this case, the positions of the sensor and the control valve may be changed. That is, the sensor may be located adjacent to the rotor 120 or the control valve may be located adjacent to the rotor 120. Further, the flowchart of FIG. 5 may be executed directly by the centrifuge controller 220, instead of the liquid feeding controller 240.

Furthermore, a dedicated air discharging control valve operating simultaneously with the air detecting sensor may be provided, instead of the three-way valve. In this case, when air is present, the dedicated air discharging control valve can discharge the air.

The present invention provides illustrative, non-limiting aspects as follows:

(1) In a first aspect, there is provided a continuous centrifuge including: a rotor configured to separate a sample; a centrifuge chamber configured to accommodate the rotor; a driving part configured to rotate the rotor; a sample line configured to continuously supply and discharge the sample to and from the rotor during rotation of the rotor; and an air detecting sensor provided to a supply side and a discharge side of the sample line.

According to the first aspect, since the air detecting sensor is provided on the supply side and the discharge side of the sample line, it is possible to confirm that the interior of the rotor is securely filled with liquid. Accordingly, the continuous centrifuge can be safely operated.

(2) In a second aspect, there is provided the continuous centrifuge according to the first aspect, wherein an air discharging part is provided to a supply side flow path and a discharge side flow path of the sample line and is configured to discharge air included in the sample line to the exterior in accordance with an output of the air detecting sensor.

According to the second aspect, since the air discharging part is provided to discharge air included in the sample line to the exterior in accordance with the output of the air detecting sensors, it is possible to discharge air to the exterior in midstream of the sample line. Accordingly, it is possible to securely fill the rotor and the sample line with liquid.

(3) In a third aspect, there is provided the continuous centrifuge according to the second aspect, wherein the air discharging part includes a control valve configured to branch the flow path to the exterior and a control unit configured to control opening/closing of the control valve in accordance with the output of the air detecting sensor.

According to the third aspect, since the air discharging part includes a control valve configured to branch the flow path to the exterior and a control unit configured to control opening/closing of the control valve in accordance with the output of the air detecting sensor, it is possible to automatically discharge air included in the sample line to the exterior by electrical control.

(4) In a fourth aspect, there is provided the continuous centrifuge according to the third aspect, wherein the control unit is configured to control the supply and discharge of the sample to and from the rotor, and wherein the control unit is configured to control the control valve to discharge the sample or waste liquid from the supply side flow path and the discharge side flow path to the exterior in accordance with the output of the air detecting sensor.

According to the fourth aspect, since the control unit controls the control valve to discharge the sample or waste liquid from the supply side flow path and the discharge side flow path to the exterior in accordance with the output of the air detecting sensor, it is possible to securely discharge air in the sample line and it is possible to maintain the flow rate of the sample injected to the rotor in a predetermined flow rate.

(5) In a fifth aspect, there is provided the continuous centrifuge according to the fourth aspect, wherein the control unit is configured to change a flow direction of the control valve and thus to discharge the sample or the waste liquid to the exterior when air is detected in the supply side flow path or the discharge side flow path in accordance with the output of the air detecting sensor.

According to the fifth aspect, since the control unit is configured to change the flow direction of the control valve when sir is detected in the supply side flow path or the discharge side flow path in accordance with the output of the air detecting sensor, the included air can be discharged by an automation control.

(6) In a sixth aspect, there is provided the continuous centrifuge according to the fifth aspect, wherein the control unit is configured to express alarm when air is detected in the supply side flow path or the discharge side flow path for a predetermined time or longer in accordance with the output of the air detecting sensor.

According to the sixth aspect, since the control unit is configured to express alarm when air is detected in the supply side flow path or the discharge side flow path for a predetermined time or longer in accordance with the output of the air detecting sensor, it is possible to quickly identify a special abnormal state including an abnormal liquid feeding state.

(7) In a seventh aspect, there is provided the continuous centrifuge according to the first aspect, wherein a liquid feeding pump and a direction switching valve having a direction switching function for switching the supply and discharge of the sample are provided to the sample line.

According to the seventh aspect, since the liquid feeding pump and the direction switching valve are provided to the sample line and the direction switching valve has a direction switching function for switching the supply and discharge of the sample, it is possible to discharge air in the sample line at both of lower supply and upper supply.

(8) In an eighth aspect, there is provided a continuous centrifuge including: a rotor configured to separate a sample; a centrifuge chamber configured to accommodate the rotor; a driving part configured to rotate the rotor; a sample line configured to continuously supply and discharge the sample to and from the rotor during rotation of the rotor; a display part configured to display an operation state; and an air detecting sensor provided to a supply side and a discharge side of the sample line, wherein the display part is configured to display whether air is detected by the air detecting sensor or not.

According to the eighth aspect, since the air detecting sensor is provided on the supply side and the discharge side of the sample line and the display part respectively displays whether air is detected by the air detecting sensor or not, an operator can easily identify whether air is included in the sample line or not.

In a ninth aspect, there is provided the continuous centrifuge according to the eighth aspect, wherein the display part displays alarm when the air detecting sensor detects air during operation of the centrifuge.

According to the ninth aspect, since the display part displays alarm when air is detected during operation of the centrifuge, an operator can quickly respond to inclusion of air in a suitable manner.

In a tenth aspect, there is provided a continuous centrifuge including: a rotor configured to separate a sample; a centrifuge chamber configured to accommodate the rotor; a driving part configured to rotate the rotor; a sample line configured to continuously supply and discharge the sample to and from the rotor during rotation of the rotor; and an air detecting sensor provided to the sample line.

According to the tenth aspect, since the air detecting sensor is provided to the sample line, it is possible to confirm that the interior of the rotor is securely filled with liquid. Accordingly, the continuous centrifuge can be safely operated.

What is claimed is:

1. A continuous centrifuge comprising:
a rotor configured to separate a sample;
a centrifuge chamber configured to accommodate the rotor;
a driving part configured to rotate the rotor;
a sample line configured to continuously supply and discharge the sample to and from the rotor during rotation of the rotor; and
an air detecting sensor provided to a supply side and a discharge side of the sample line.

2. The continuous centrifuge according to claim 1,
wherein an air discharging part is provided to a supply side flow path and a discharge side flow path of the sample line and is configured to discharge air included in the sample line to the exterior in accordance with an output of the air detecting sensor.

3. The continuous centrifuge according to claim 2,
wherein the air discharging part includes a control valve configured to branch the flow path to the exterior and a control unit configured to control opening/closing of the control valve in accordance with the output of the air detecting sensor.

4. The continuous centrifuge according to claim 3,
wherein the control unit is configured to control the supply and discharge of the sample to and from the rotor, and
wherein the control unit is configured to control the control valve to discharge the sample or waste liquid from the supply side flow path and the discharge side flow path to the exterior in accordance with the output of the air detecting sensor.

5. The continuous centrifuge according to claim 4,
wherein the control unit is configured to change a flow direction of the control valve and thus to discharge the sample or the waste liquid to the exterior when air is detected in the supply side flow path or the discharge side flow path in accordance with the output of the air detecting sensor.

6. The continuous centrifuge according to claim 5,
wherein the control unit is configured to express alarm when air is detected in the supply side flow path or the discharge side flow path for a predetermined time or longer in accordance with the output of the air detecting sensor.

7. The continuous centrifuge according to claim 1,
wherein a liquid feeding pump and a direction switching valve having a direction switching function for switching the supply and discharge of the sample are provided to the sample line.

8. A continuous centrifuge comprising:
a rotor configured to separate a sample;
a centrifuge chamber configured to accommodate the rotor;
a driving part configured to rotate the rotor;
a sample line configured to continuously supply and discharge the sample to and from the rotor during rotation of the rotor;
a display part configured to display an operation state; and
an air detecting sensor provided to a supply side and a discharge side of the sample line,
wherein the display part is configured to display whether air is detected by the air detecting sensor or not.

9. The continuous centrifuge according to claim 8,
wherein the display part displays alarm when the air detecting sensor detects air during operation of the centrifuge.

10. A continuous centrifuge comprising:
a rotor configured to separate a sample;
a centrifuge chamber configured to accommodate the rotor;
a driving part configured to rotate the rotor;
a sample line configured to continuously supply and discharge the sample to and from the rotor during rotation of the rotor; and
an air detecting sensor provided to the sample line.
